(19) United States
(12) Patent Application Publication
(10) Pub. No.: US 2026/0179856 A1
(43) Pub. Date: Jun. 25, 2026

(54) SOLID ELECTROLYTIC CAPACITOR

(71) Applicant: Panasonic Intellectual Property Management Co., Ltd., Osaka (JP)

(72) Inventors: Yuji Miyachi, Saga Ken (JP); Tomoaki Kida, Saga Ken (JP); Eizo Fujii, Osaka Fu (JP)

(73) Assignee: Panasonic Intellectual Property Management Co., Ltd., Osaka (JP)

(21) Appl. No.: 19/426,833

(22) Filed: Dec. 19, 2025

(30) Foreign Application Priority Data
Dec. 24, 2024 (JP) 2024-227657

(51) Int. Cl. H01G 9/052; H01G 9/012; H01G 9/15

(52) U.S. Cl. CPC H01G 9/052; H01G 9/012; H01G 9/15

(57) ABSTRACT

A solid electrolytic capacitor includes: a capacitor element including an anode part, and a cathode part; an anode lead frame; a cathode lead frame; and a package body that covers the capacitor element, a portion of the anode lead frame, and a portion of the cathode lead frame. The package body has a package bottom surface located on the side to be mounted on a substrate and a package top surface located on the side opposite the package bottom surface. The cathode lead frame and a first cathode surface of the cathode part on the side toward the package top surface are bonded with a conductive adhesive. The first cathode surface has a first protrusion protruding toward the cathode lead frame. The angle formed between the package top surface and a first anode surface of the anode part on the side toward the package top surface is less than 1.4°.

### CROSS REFERENCE TO RELATED APPLICATION

The present application is based on and claims priority under 35 U.S.C. § 119 to Japanese Patent Application No. 2024-227657, filed on Dec. 24, 2024, of which entire content is incorporated herein by reference into the present application.

### TECHNICAL FIELD

The present disclosure relates to a solid electrolytic capacitor.

### BACKGROUND

Japanese Laid-Open Patent Publication No. 2011-129545 proposes “a solid electrolytic capacitor including: an anode body that has a porous surface and is made of a valve metal, and from which an anode lead is led out; a dielectric layer formed on the surface of the anode body; a solid electrolyte layer formed on the surface of the dielectric layer and made of a conductive polymer; and a graphite paste layer and a silver paste layer sequentially formed on the surface of the solid electrolyte layer, wherein the silver paste layer includes a first silver paste layer and a second silver paste layer, and the adhesion strength of the silver paste constituting the first silver paste layer to the graphite paste layer is higher than the adhesion strength of the silver paste constituting the second silver paste layer to the graphite paste layer”.

A solid electrolytic capacitor includes lead frames led out from the anode part and the cathode part. Portions of the respective lead frames are led out of the package body (external molded resin) covering the capacitor element.

Here, when a portion of the surface of the cathode part to which the cathode lead frame is connected is not flat, the capacitor element may incline inside the package body such that one of the corners of the capacitor element is located close to the bottom surface or the top surface of the package body.

When the capacitor element is disposed at an incline inside the package body, peeling between the material layers of the solid electrolytic capacitor is likely to occur due to uneven distribution of thermal stresses generated upon abrupt temperature change.

### SUMMARY

One aspect of the present disclosure relates to a solid electrolytic capacitor. The solid electrolytic capacitor includes: a capacitor element including an anode part including a porous sintered product, and a cathode part; an anode lead frame electrically connected to the anode part; a cathode lead frame electrically connected to the cathode part; and a package body that covers the capacitor element, a portion of the anode lead frame, and a portion of the cathode lead frame, wherein the package body has a package bottom surface located on a side to be mounted on a substrate and a package top surface located on a side opposite the package bottom surface, the anode part has a first anode surface located on a side toward the package top surface, and a second anode surface located on a side opposite the first anode surface, the cathode part has a first cathode surface located on the side toward the package top surface, and a second cathode surface located on a side opposite the first cathode surface, the first cathode surface and the cathode lead frame are bonded with a conductive adhesive, the first cathode surface has a first protrusion protruding toward the cathode lead frame, and an angle formed between the first anode surface and the package top surface is less than 1.4°.

### BRIEF DESCRIPTION OF DRAWINGS

FIG. 1 is a cross-sectional view of an example of the configuration of a solid electrolytic capacitor according to an embodiment of the present disclosure.

FIG. 2 is a schematic explanatory diagram of the adhesion between a capacitor element and a cathode lead frame.

FIG. 3 is an explanatory diagram of the inclination of the capacitor element placed within a package body 40.

FIG. 4 is an explanatory diagram of the inclination of an inner part of the cathode lead frame.

FIG. 5 is a bottom view of the solid electrolytic capacitor, the package body of which is removed.

### DETAILED DESCRIPTION

The following describes a solid electrolytic capacitor according to the present disclosure by way of examples. However, the present disclosure is not limited to the examples described below. In the following description, specific numerical values and materials may be exemplified in some cases, but other numerical values and other materials may be adopted as long as the effects of the present disclosure can be obtained.

### 1 Solid Electrolytic Capacitor

The solid electrolytic capacitor according to the present disclosure includes a capacitor element, an anode lead frame, a cathode lead frame, and a package body. Usually, the solid electrolytic capacitor is substantially rectangular parallelepiped in shape as a whole. In this case, the package body is also substantially rectangular parallelepiped in shape. The package body has a package bottom surface located on the side to be mounted on a substrate, and a package top surface located on the side opposite the package bottom surface. As described above, in the present disclosure, “bottom” is used for the names of the respective constituent elements located on the side to be mounted on the substrate, and “top” is used for the names of the respective constituent elements located on the opposite side thereto. The direction toward the package bottom surface and the package top surface is referred to as “vertical direction”. However, depending on the substrate on which the solid electrolytic capacitor is to be mounted, the attitude of the substrate, or the like, the package bottom surface does not necessarily face downward, and the package top surface does not necessarily face upward.

### 1.1 Capacitor Element

The capacitor element includes an anode part and a cathode part.

### 1.1.1 Anode Part

The anode part includes an anode body including a dielectric layer, and an anode wire extending from the implantation surface of the anode body. The anode part has a first anode surface located on the side toward the package top surface and a second anode surface located opposite the first anode surface.

The anode body is a porous sintered product having a rectangular parallelepiped shape obtained by sintering metal particles, for example. As the metal particles, particles of a valve metal such as titanium (Ti), tantalum (Ta), or niobium (Nb) are used. One or two or more types of metal particles are used for the anode body. The metal particles may be made of an alloy of two or more metals. For example, an alloy containing the valve metal and silicon, vanadium, boron, or the like can be used. Alternatively, a compound containing the valve metal and a typical element such as nitrogen may be used. The alloy of the valve metal contains the valve metal as a main component and preferably contains 50 at % or more of the valve metal.

The anode wire is formed of a conductive material. The material of the anode wire is not particularly limited, and examples thereof include copper, aluminum, and aluminum alloys besides the valve metal. The materials constituting the anode body and the anode wire may be the same or different. The cross-sectional shape of the anode wire is not particularly limited, and examples thereof include a circular shape, a track shape (a shape consisting of straight lines parallel to each other and two curves connecting the ends of these straight lines), an elliptical shape, a rectangular shape, and a polygonal shape. Among these, the track shape is preferable from the viewpoint of roll suppression and easy positioning when welding to the anode lead frame. The diameter of the anode wire (the major diameter in a case of the track shape or the elliptical shape) is also not particularly limited, and is, for example, 0.1 mm or more and 1.0 mm or less.

A dielectric layer is formed on the surface of the anode body. The dielectric layer is formed of a metal oxide, for example. Examples of a method of forming a layer containing a metal oxide on the surface of the anode body include anodization of the surface of the anode body by immersing the anode body in a conversion solution, and heating of the anode body in an oxygen-containing atmosphere. The dielectric layer is not limited to the above-described layer containing a metal oxide, provided that it possesses insulative properties.

### 1.1.2 Cathode Part

The cathode part includes a solid electrolyte layer formed on the dielectric layer, and a cathode layer covering the surface of the solid electrolyte layer. The cathode part has a first cathode surface located on the side toward the package top surface and a second cathode surface located opposite the first cathode surface.

The solid electrolyte layer should be formed to cover at least a portion of the dielectric layer. For example, a manganese compound or a conductive polymer is used for the solid electrolyte layer. Examples of the conductive polymer include polypyrrole, polythiophene, polyfuran, polyaniline, polyacetylene, polyphenylene, polyparaphenylene vinylene, polyacene, polythiophene vinylene, polyfluorene, polyvinylcarbazole, polyvinylphenol, polypyridine, and derivatives of these polymers. Any of these may be used alone or in combination of two or more types. Alternatively, the conductive polymer may be a copolymer of two or more types of monomers. Among these, polythiophene, polyaniline, and polypyrroleare preferable, for example, because of having excellent conductivity. Among these, polypyrrole is preferable because of having excellent water repellency.

The solid electrolyte layer containing the above-described conductive polymer is formed, for example, by polymerizing a raw material monomer on the dielectric layer. Alternatively, it is formed by applying a liquid containing the above-described conductive polymer to the dielectric layer. The solid electrolyte layer is composed of one or two or more solid electrolyte layers. When the solid electrolyte layer is composed of two or more layers, the conductive polymers used in the respective layers may differ from each other, for example, in composition or formation method (polymerization method).

The cathode layer includes, for example, a carbon layer formed to cover the solid electrolyte layer, and a metal paste layer formed on the surface of the carbon layer. The carbon layer contains a resin and a conductive carbon material such as graphite. The metal paste layer contains metal (e.g., silver) particles and a resin, for example. Note that the composition of the cathode layer is not limited to the above composition. The composition of the cathode layer should be any composition having a current collecting function.

### 1.2 Lead Frame

The anode lead frame is electrically connected to the anode part. The cathode lead frame is electrically connected to the cathode part.

### 1.2.1 Anode Lead Frame

The anode lead frame is electrically connected to the anode body via an anode wire. The material of the anode lead frame is not particularly limited as long as it is electrochemically and chemically stable and has conductivity. The material of the anode lead frame may be a metal or a non-metal. The anode lead frame is usually a frame-shaped member cut out from a metal foil and has a shape of, for example, a flat plate. The thickness of the anode lead frame (the distance between the main surfaces of the anode lead frame) is preferably 25 μm or more and 200 μm or less from the viewpoint of height reduction, and more preferably 25 μm or more and 150 μm or less.

The anode lead frame may be bonded to the anode wire with a conductive adhesive or solder, or may be bonded to the anode wire by resistance welding or laser-welding. The conductive adhesive is a mixture of the later-described thermosetting resin and carbon particles or metal particles, for example.

### 1.2.2 Cathode Lead Frame

The cathode lead frame is electrically connected to the cathode part. The material of the cathode lead frame is also not particularly limited as long as it is electrochemically and chemically stable and has conductivity. The material of the cathode lead frame may be metal or a non-metal. The cathode lead frame is usually a frame-shaped member cut out from a metal foil. The shape thereof is not particularly limited, and is, for example, a flat plate shape. The thickness of the cathode lead frame is preferably 25 μm or more and 200 μm or less from the viewpoint of height reduction, and more preferably 25 μm or more and 150 μm or less.

### 1.3 Package Body

The package body covers the capacitor element, a portion of the anode lead frame, and a portion of the cathode lead frame. As described above, the package body has a package bottom surface located on the side to be mounted on a substrate, and a package top surface on the side located opposite the package bottom surface.

The package body serves to electrically isolate the anode lead frame and the cathode lead frame, and is formed of an insulative material. The package body contains a cured product of a thermosetting resin, for example. Examples of the thermosetting resin include epoxy resins, phenolic resins, silicone resins, melamine resins, urea resins, alkyd resins, polyurethanes, polyimides, and unsaturated polyesters.

### 1.4 Relationship Among Capacitor Element, Lead Frames, and Package Body

The first cathode surface of the cathode part and the cathode lead frame are bonded with a conductive adhesive. The first cathode surface has a first protrusion protruding toward the cathode lead frame. A first height of the first protrusion toward the cathode lead frame is not sufficiently small relative to the thickness of the cathode layer. However, the angle formed between the first anode surface and the package top surface is set to less than 1.4°. The first protrusion is formed of, for example, the metal paste layer constituting the cathode layer, which is formed in a metal paint coating step in the manufacturing process, but is not limited thereto. Examples of the conductive adhesive include, but are not limited to, those that are thermoset and have a viscosity of about 5 to 150 Pa·s at 25° C. By bringing the apex of the first protrusion into contact with or as close as possible to the cathode lead frame, favorable conduction between the cathode part and the cathode lead frame can be achieved. However, when the first protrusion is in contact with the cathode lead frame, it may hinder horizontal placement of the capacitor element. Therefore, it is preferable that the first protrusion is out of contact with the cathode lead frame.

The first height corresponds to a difference Δd (=dmx−dmn) between a maximum distance dmx from the first anode surface to the first cathode surface and a minimum distance dmn from the first anode surface to the first cathode surface. Δd is, for example, 1.1 times or more dmn, and can be 5 times or more. However, Δd is preferably limited to no more than 2 times dmn.

As a result of the angle formed between the first anode surface and the package top surface being set to less than 1.4°, the positions of the opposite corners of the capacitor element are not excessively close to either the package bottom surface or the package top surface within the package body, and can be said to be placed generally parallel to the package bottom surface and the package top surface. This suppresses uneven distribution of thermal stresses and peeling between the material layers of the solid electrolytic capacitor.

The anode lead frame and the cathode lead frame may be exposed from the package body at respective positions closer to the package top surface than the center plane (i.e., the center plane in the vertical direction) of the package body such that a first distance between the package top surface and the first anode surface is equal to a second distance between the package bottom surface and the second anode surface of the anode part located opposite the first anode surface. In other words, the respective positions at which the anode lead frame and the cathode lead frame are exposed from the package body are determined so that the capacitor element is positioned at the vertical center inside the package body. This more remarkably suppresses uneven distribution of thermal stresses and peeling between the material layers of the solid electrolytic capacitor.

The conductive adhesive may be disposed to fill the gap between the first cathode surface and the cathode lead frame. This maintains the capacitor element and the cathode lead frame in parallel to each other while reducing the influence of the first protrusion of the first cathode surface as much as possible.

In connecting the first cathode surface having the first protrusion to the flat surface of the cathode lead frame so as to set the angle formed between the cathode lead frame and the package top surface to less than 1.4°, a delicate attitude alignment process may be required. In this case, it is effective to fill the gap between the first cathode surface and the cathode lead frame by interposing the conductive adhesive having flowability between the cathode lead frame and the first cathode surface to allow the conductive adhesive to flow therebetween. During the conductive adhesive flowing therebetween, a portion of the first cathode surface and a portion of the cathode lead frame may be directly contacted with each other.

The cathode lead frame may include an inner part, an intermediate part, and a lead-out part. The inner part is bonded to the first cathode surface of the cathode part. The intermediate part is continuous with the inner part and is bent along the side surface of the capacitor element. The lead-out part is continuous with the intermediate part and is bent away from the intermediate part to be led out of the package body. In this case, it is preferable that the angle formed between the inner part and the package top surface is 0.15° or more to bring the distal end of the inner part further close to the first cathode surface. This facilitates adjustment of the attitude of the capacitor element by utilizing the flow of the conductive adhesive applied between the first cathode surface and the cathode lead frame.

The cathode lead frame may be provided with a through-hole formed in the vicinity of the boundary between the inner part and the intermediate part. This can suppress an adverse effect on the attitude of the capacitor element caused due to the accumulation of an excessive amount of the conductive adhesive adhering to the first cathode surface.

The second cathode surface of the cathode part located on the side toward the package bottom surface may have a second protrusion protruding toward the package bottom surface. The anchor effect by the second protrusion can suppress displacement of the capacitor element in the direction along the package bottom surface or the package top surface from its normal position within the package body. The second protrusion is formed of the cathode layer (e.g., the applied metal paste layer), but is not limited thereto.

Preferably, the first height of the first protrusion toward the cathode lead frame is smaller than a second height of the second protrusion toward the package bottom surface. That is, it is desirable that the first cathode surface connected to the cathode lead frame does not have an excessively large protrusion from the viewpoint of suppressing an adverse effect on the attitude of the capacitor element. On the other hand, it is desirable that the second protrusion of the second cathode surface, which is anchored to package body, is large as long as it does not involve any disadvantage.

### 2 Specific Examples of Solid Electrolytic Capacitor

In the following, an exemplary solid electrolytic capacitor according to the present disclosure is described in detail with reference to the accompanying drawings. The above-described constituent elements may be applied to the constituent elements of the exemplary solid electrolytic capacitor described below, and may be altered based on the above description. Further, the matters described below may be applied to the above-described embodiments. Among the constituent elements of the solid electrolytic capacitor described below, a constituent element that is not essential to the solid electrolytic capacitor according to the present disclosure may be omitted. It should be noted that the drawings indicated below are schematic and do not accurately reflect the shape, number, and the like of the actual members.

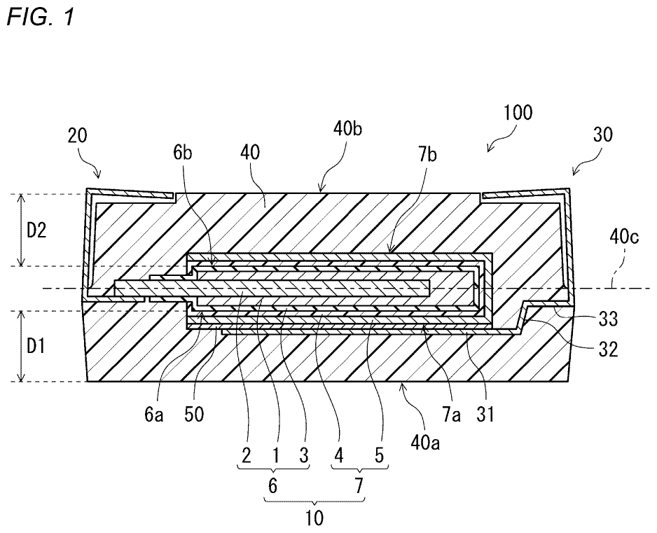

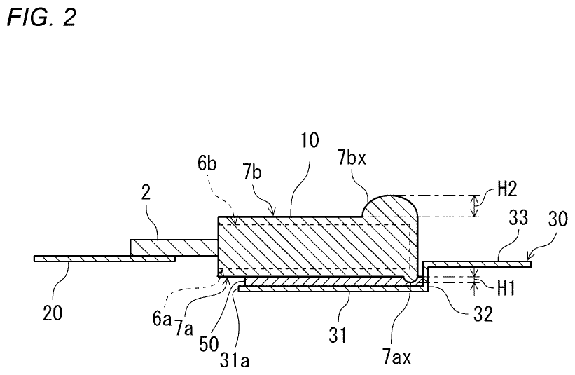

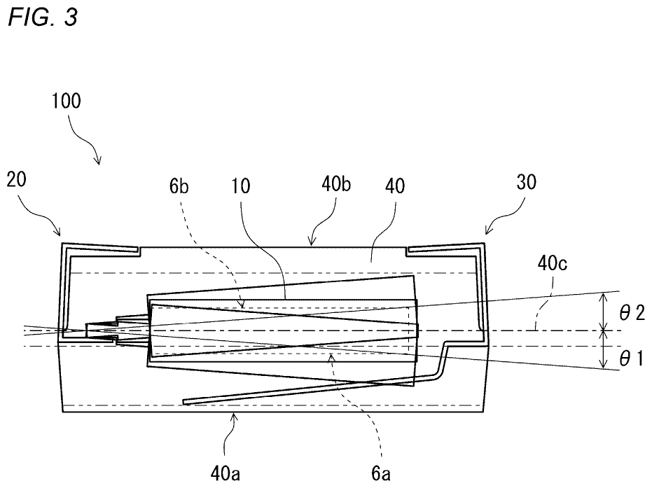

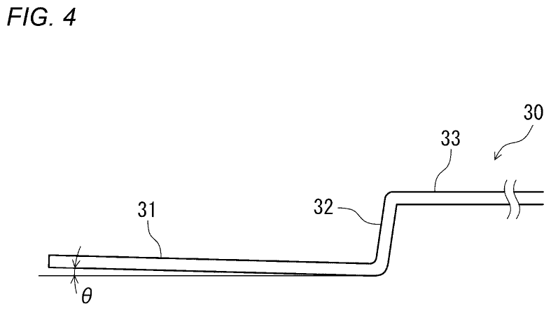

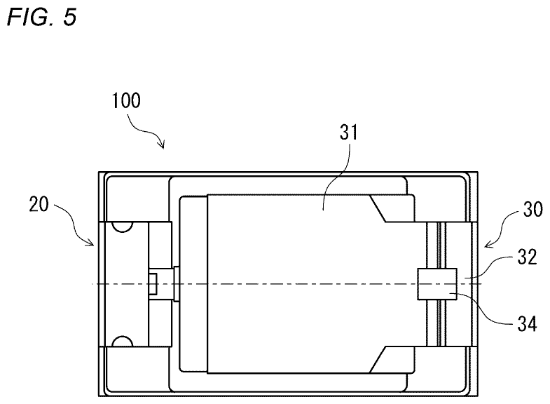

A solid electrolytic capacitor 100 of an embodiment is described below. FIG. 1 is a cross-sectional view of an example of the configuration of the solid electrolytic capacitor 100 according to an embodiment of the present disclosure. FIG. 2 is a schematic explanatory diagram of the adhesion between a capacitor element 10 and a cathode lead frame 30. FIG. 3 is an explanatory diagram of the inclination of the capacitor element 10 placed within a package body 40. FIG. 4 is an explanatory diagram of the inclination of an inner part 31 of the cathode lead frame 30. FIG. 5 is a bottom view of the solid electrolytic capacitor 100, the package body 40 of which is removed.

As illustrated in FIG. 1, the solid electrolytic capacitor 100 includes a capacitor element 10, an anode lead frame 20, a cathode lead frame 30, and a package body 40.

The capacitor element 10 includes an anode part 6 and a cathode part 7. The anode part 6 includes an anode wire 2 and an anode body 1 including a dielectric layer 3, and has a first anode surface 6a (the lower surface in FIG. 1) and a second anode surface 6b (the upper surface in FIG. 1). The cathode part 7 includes a solid electrolyte layer 4 formed on the dielectric layer 3 and a cathode layer 5 covering the surface of the solid electrolyte layer 4, and has a first cathode surface 7a (the lower surface in FIG. 1) and a second cathode surface 7b (the upper surface in FIG. 1).

The anode lead frame 20 is electrically connected to the anode part 6. Also, the cathode lead frame 30 is electrically connected to the cathode part 7.

The package body 40 covers the capacitor element 10, a portion of the anode lead frame 20, and a portion of the cathode lead frame 30. The package body 40 has a package bottom surface 40b located on the side (the upper side in FIG. 1) to be mounted on a substrate, and a package top surface 40a located on the side (the lower side in FIG. 1) opposite the package bottom surface 40b.

The anode lead frame 20 and the cathode lead frame 30 are exposed from the package body 40 at respective positions closer to the package top surface 40a than a center plane 40c of the package body 40 such that a first distance D1 between the package top surface 40a and the first anode surface 6a is equal to a second distance D2 between the second anode surface 6b and the package bottom surface 40b.

As illustrated in FIG. 2, the first cathode surface 7a of the cathode part 7 and the cathode lead frame 30 are bonded with a conductive adhesive 50. The first cathode surface 7a has a first protrusion 7ax protruding toward the cathode lead frame 30. The conductive adhesive 50 is disposed between the first cathode surface 7a and the cathode lead frame 30 to fill the gap therebetween. Although the first protrusion 7ax illustrated is out of contact with the later-described inner part 31 of the cathode lead frame 30, there involves no problem even when the first protrusion 7ax is in contact with the inner part 31. However, since there is a possibility that such contact hinders the horizontal placement of the capacitor element 10, a state in which the capacitor element is out of contact therewith is preferable.

The second cathode surface 7b has a second protrusion 7bx protruding toward the package bottom surface 40b. A first height H1 of the first protrusion 7ax toward the cathode lead frame 30 is smaller than a second height H2 of the second protrusion 7bx toward the package bottom surface 40 b. The first height H1 is, for example, 90% or less of the second height H2, and preferably 50% or less.

The cathode lead frame 30 includes an inner part 31 that is bonded to the first cathode surface 7a of the cathode part 7, an intermediate part 32 that is continuous with the inner part 31 and is bent along the side surface of the capacitor element 10, and a lead-out part 33 that is continuous with the intermediate part 32 and is bent away from the intermediate part 32 to be led out of the package body 40.

As illustrated in FIG. 3, an angle θ1 formed between the first anode surface 6a of the capacitor element 10 and the package top surface 40 a is preferably less than 1.4°. It is preferable that an angle θ2 formed between the second anode surface 6b of the capacitor element 10 and the package bottom surface 40 b is less than 4°.

As illustrated in FIG. 4, an angle θ formed between the inner part 31 and the package top surface 40 a is preferably 0.15° or more to bring a distal end 31 a of the inner part 31 of the cathode lead frame 30 further close to the first cathode surface 7a.

As illustrated in FIG. 5, the cathode lead frame 30 is provided with a through-hole 34 formed in the vicinity of the boundary between the inner part 31 and the intermediate part 32.

The present disclosure is not limited to the above-described embodiments, and can be implemented in various aspects without departing from the gist thereof. Further, various disclosures can be formed by appropriately combining the constituent elements disclosed in the above embodiments. For example, some constituent elements may be deleted from all the constituent elements indicated in the embodiments. In the drawings, the respective constituent elements are schematically illustrated in order to facilitate understanding, and the number and the like of the respective constituent elements illustrated may differ from actual ones for convenience's sake of drawing preparation. In addition, the constituent elements described in the above embodiments are merely exemplary and are not particularly limited. Various alterations can be made without substantially departing from the advantageous effects of the present disclosure.

### 3 Supplemental Remarks

According to the above description of the embodiments, the following techniques are disclosed.

### Technique 1

A solid electrolytic capacitor including:
a capacitor element including an anode part including a porous sintered product, and a cathode part;
an anode lead frame electrically connected to the anode part;
a cathode lead frame electrically connected to the cathode part; and
a package body that covers the capacitor element, a portion of the anode lead frame, and a portion of the cathode lead frame,
wherein the package body has a package bottom surface located on a side to be mounted on a substrate and a package top surface located on a side opposite the package bottom surface,
the anode part has a first anode surface located on a side toward the package top surface, and a second anode surface located on a side opposite the first anode surface,
the cathode part has a first cathode surface located on the side toward the package top surface, and a second cathode surface located on a side opposite the first cathode surface,
the first cathode surface and the cathode lead frame are bonded with a conductive adhesive,
the first cathode surface has a first protrusion protruding toward the cathode lead frame, and
an angle formed between the first anode surface and the package top surface is less than 1.4°.

### Technique 2

The solid electrolytic capacitor according to Technique 1, wherein the anode lead frame and the cathode lead frame are exposed from the package body at respective positions closer to the package top surface than a center plane of the package body such that a first distance between the package top surface and the first anode surface is equal to a second distance between the second anode surface and the package bottom surface.

### Technique 3

The solid electrolytic capacitor according to Technique 1 or 2, wherein the conductive adhesive is disposed between the first cathode surface and the cathode lead frame to fill a gap therebetween.

### Technique 4

The solid electrolytic capacitor according to any one of Techniques 1 to 3, wherein the cathode lead frame includes:
an inner part that is bonded to the first cathode surface of the cathode part;
an intermediate part that is continuous with the inner part and is bent along a side surface of the capacitor element; and
a lead-out part that is continuous with the intermediate part and is bent away from the intermediate part to be led out of the package body, and

an angle formed between the inner part and the package top surface is 0.15° or more to bring a distal end of the inner part further close to the first cathode surface.

### Technique 5

The solid electrolytic capacitor according to Technique 4, wherein the cathode lead frame is provided with a through-hole formed in the vicinity of a boundary between the inner part and the intermediate part.

### Technique 6

The solid electrolytic capacitor according to any one of Techniques 1 to 5, wherein the second cathode surface has a second protrusion protruding toward the package bottom surface.

### Technique 7

The solid electrolytic capacitor according to Technique 6, wherein a first height of the first protrusion toward the cathode lead frame is smaller than a second height of the second protrusion toward the package bottom surface.

### REFERENCE NUMERALS

1 Anode body
2 Anode wire
3 Dielectric layer
4 Solid electrolyte layer
5 Cathode layer
6 Anode part
6a First anode surface
6b Second anode surface
7 Cathode part
7a First cathode surface
7ax First protrusion
7b Second cathode surface
7bx Second protrusion
10 Capacitor element
20 Anode lead frame
30 Cathode lead frame
31 Inner part
32 Intermediate part
33 Lead-out part
34 Through-hole
40 Package body
40a Package top surface
40b Package bottom surface
50 Conductive adhesive
100 Solid electrolytic capacitor

What is claimed is:

1. A solid electrolytic capacitor comprising:
a capacitor element including an anode part including a porous sintered product, and a cathode part;
an anode lead frame electrically connected to the anode part;
a cathode lead frame electrically connected to the cathode part; and
a package body that covers the capacitor element, a portion of the anode lead frame, and a portion of the cathode lead frame,
wherein the package body has a package bottom surface located on a side to be mounted on a substrate and a package top surface located on a side opposite the package bottom surface,
the anode part has a first anode surface located on a side toward the package top surface, and a second anode surface located on a side opposite the first anode surface,
the cathode part has a first cathode surface located on the side toward the package top surface, and a second cathode surface located on a side opposite the first cathode surface,
the first cathode surface and the cathode lead frame are bonded with a conductive adhesive,
the first cathode surface has a first protrusion protruding toward the cathode lead frame, and
an angle formed between the first anode surface and the package top surface is less than 1.4°.

2. The solid electrolytic capacitor according to claim 1,
wherein the anode lead frame and the cathode lead frame are exposed from the package body at respective positions closer to the package top surface than a center plane of the package body such that a first distance between the package top surface and the first anode surface is equal to a second distance between the second anode surface and the package bottom surface.

3. The solid electrolytic capacitor according to claim 1,
wherein the conductive adhesive is disposed between the first cathode surface and the cathode lead frame to fill a gap therebetween.

4. The solid electrolytic capacitor according to claim 1,
wherein the cathode lead frame includes:
an inner part that is bonded to the first cathode surface of the cathode part;
an intermediate part that is continuous with the inner part and is bent along a side surface of the capacitor element; and
a lead-out part that is continuous with the intermediate part and is bent away from the intermediate part to be led out of the package body, and
an angle formed between the inner part and the package top surface is 0.15° or more to bring a distal end of the inner part further close to the first cathode surface.

5. The solid electrolytic capacitor according to claim 4,
wherein the cathode lead frame is provided with a through-hole formed in the vicinity of a boundary between the inner part and the intermediate part.

6. The solid electrolytic capacitor according to claim 1,
wherein the second cathode surface has a second protrusion protruding toward the package bottom surface.

7. The solid electrolytic capacitor according to claim 6,
wherein a first height of the first protrusion toward the cathode lead frame is smaller than a second height of the second protrusion toward the package bottom surface.
